(19) United States
(12) Patent Application Publication
(10) Pub. No.: US 2010/0280990 A1
(43) Pub. Date: Nov. 4, 2010

(54) ETL FOR PROCESS DATA WAREHOUSE

(76) Inventors: Maria G. Castellanos, Sunnyvale, CA (US); Umeshwar Dayal, Saratoga, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/432,933

(22) Filed: Apr. 30, 2009

(51) Int. Cl. G06F 17/30

(52) U.S. Cl. 707/602; 707/E17.009

(57) ABSTRACT

One embodiment is a method extract information technology (IT) events that indicate start and completion times of a business process. The method transforms the IT events into business data changes that are agnostic to multiple different ETL implementation languages and transforms the business data changes into execution data. Execution data is stored in a data warehouse.

### CROSS-REFERENCE TO RELATED APPLICATIONS

This application relates to the patent application entitled “Identifying Events that Correspond to a Modified Version of a Process” filed on Aug. 2, 2006 and having Ser. No. 11/497,654 and being incorporated herein by reference.

### BACKGROUND

Databases are electronic filing systems that store records or data in a computer system. The amount of data stored in database systems has been continuously increasing over the last few decades. Database management systems manage large volumes of data that need to be efficiently accessed, manipulated, and analyzed.

One aspect of the database systems is an Extract-Transform-Load (ETL) process. This process extracts data from a source, transforms the data for operational requirements, and then loads the data into the database or data warehouse.

Designing and implementing the ETL process for warehousing data is complex task that is manually performed by experts. In the context of business processes, a method to automate the design of ETL is presented.

### BRIEF DESCRIPTION OF THE DRAWINGS

FIG. 1A shows an exemplary step table that is associated with each execution of an event in a process in accordance with an exemplary embodiment.

FIG. 1B shows an exemplary process table that is associated with each execution of a process in accordance with an exemplary embodiment.

FIG. 2 is a flow chart that enables a user to describe an abstracted view of a process and how progressions map to underlying Information Technology (IT) events in accordance with an exemplary embodiment.

FIG. 3 illustrates a system for extracting, transforming and loading (ETL) a process data warehouse with process execution data in accordance with an exemplary embodiment.

FIG. 4 shows a two-phase mapping process to automate the design and implementation of an ETL process that populates a business process warehouse in accordance with an exemplary embodiment.

FIG. 5 shows mapping generation levels of a mapping generator in accordance with an exemplary embodiment.

FIG. 6 shows a computer system in accordance with an exemplary embodiment.

### DETAILED DESCRIPTION

Exemplary embodiments in accordance with the invention include apparatus, systems, and methods for automating Extract-Transform-Load (ETL) design and implementation for business process warehousing.

One exemplary embodiment for business process warehousing uses a set of predefined templates. The templates capture semantics of transformation from events in an IT infrastructure captured in logs to business data changes. Other templates capture semantics of the transformation from business data changes to process execution data. These templates correspond to two phases of the transformation process. In each phase there are two levels of mapping: logical mappings and physical mappings. Both mappings are prescriptive but the first ones are agnostic with respect to the ETL implementation language whereas the latter ones are not since they are already executable.

From high level mappings specified by a user during a modeling phase and specific events that occur, templates get instantiated into logical mappings and then translated into physical mappings. The transformation stage is preceded by an extraction stage where events are extracted from the logs into a staging area where a comparison process takes place to identify new events.

Automation of the whole ETL design and implementation process leads to a large reduction in the time and effort and leads to a higher quality implementation of the ETL process as compared to a traditional, manual approach that takes many cycles to end up with a lower quality design.

In order to assist in a further discussion of exemplary embodiments in accordance with the invention (i.e., exemplary embodiments), the description is divided with headings at various sections.

Overview

Events generated in the Information Technology (IT) infrastructure as business processes are executed and used to build event sets for the process. A single business process can have many different events, such as sending messages, contacting service providers, filling a shopping cart, buying the goods and providing shipping information, etc. Events are instantaneous and therefore a timestamp of their occurrence can be associated to them.

Data generated from the execution of a process and corresponding events are stored so it is possible to keep a trace of the process progression. Events are collected with an identifier to correlate the events to each other and corresponding process execution. The identifiers enable a linking to occur between events since many events can exist for a single process.

Exemplary embodiments provide systems and methods to extract, transform, and load the captured events into a data warehouse. The events are transformed into process execution data rows and inserted into tables in the data warehouse (called a process warehouse).

Some events start a process execution, others start a process step (also called task or activity), others end a process step, and others end a process execution. The events that start a process or step execution are transformed into a new row to be loaded in the corresponding process data warehouse table. The events that end a process or step are transformed into updates to previously inserted rows in the process warehouse. Further, for each event its occurrence time (called timestamp) is stored. These times enable business intelligence applications to generate reports on the performance of business processes and to build analytics on top of this data. For example, after a user orders a personal computer (PC) online, the PC moves through various steps, such as from a manufacturing facility, to a distribution center, to shipping, and ultimately to the user. The time of occurrence of the events that signal the start and end of each one of these steps is known and stored in the process warehouse. For example, the timestamp of the end of the shipping dispatch step might be Aug. 28, 2009 at 9 A.M., and the start of the in-transit step might be August 29 at 3 P.M. When these events are transformed into rows and loaded into the process warehouse, business intelligence reports can derive that it took 30 hours for the PC to move from a shipping location to transit to the user/customer.

In the process warehouse, a table is maintained for the various steps of processes. The events signaling the start or end of a step are mapped to new rows or updates, respectively, on existing rows in the process warehouse. For example, a user clicks the submit button of a we form for ordering goods. This event signals the start of a new ordering process execution and at the same time the start of a receive_order step execution. Once the event that signals the end of a step occurs, another event is generated when the next step commences. For example, a person at a manufacturing facility retrieves a user's goods (e.g., a PC) or begins to prepare the goods for shipping. Each of these events is mapped to an insert or update to the process warehouse.

Timestamps associated to events are used to track when process steps start and stop. In this manner, the data warehouse stores a history of executions of the process, in particular, its progression.

Business intelligence (BI) is built on top of the process warehouse. Once the data is stored in the process warehouse, it is retrieved by the BI applications to analyze and report on the process execution. For example, a user can determine if Service Level Agreement (SLA) terms are being met. Continuing with the example above, 30 hours to ship a product to a customer could violate a SLA term that required the product to be shipped within 24 hours.

Two Phase, Two-Level Transformation

Exemplary embodiments in accordance with the invention automate the design and implementation of ETL of business process executions. The source data consists of logs of IT events that indicate the start and completion of the activities of the business process performed on the underlying IT infrastructure. Exemplary embodiments provides methods and systems to interpret and correlate these IT events. The target is the data warehouse where the process execution data will be loaded (called process warehouse). The schema of the data warehouse is designed to allow querying of task and process execution data for process monitoring, reporting, and analysis. To load the process warehouse, the source data undergoes some transformations. Exemplary embodiments construct predefined generic templates that embody the semantics of the transformations.

Transformation occurs in two phases. IT events are transformed into business data changes, and the latter are transformed into process progression data. At the same time, it is a two level approach where the transformations first occur at the logical level that is agnostic the implementation language and/or ETL tools. The logical transformations are translated to physical ones that are executable and therefore depend on the implementation language. Part of the approach is also an extraction mechanism that precedes the transformation.

Process Data Warehouse Model

Exemplary embodiments build or generate a process data warehouse model that is designed to be generic to support the analysis of arbitrary business processes, in particular the computation of a large variety of process metrics. The model includes a step (i.e., task) execution data table and a process execution data table that are associated with each execution of a process.

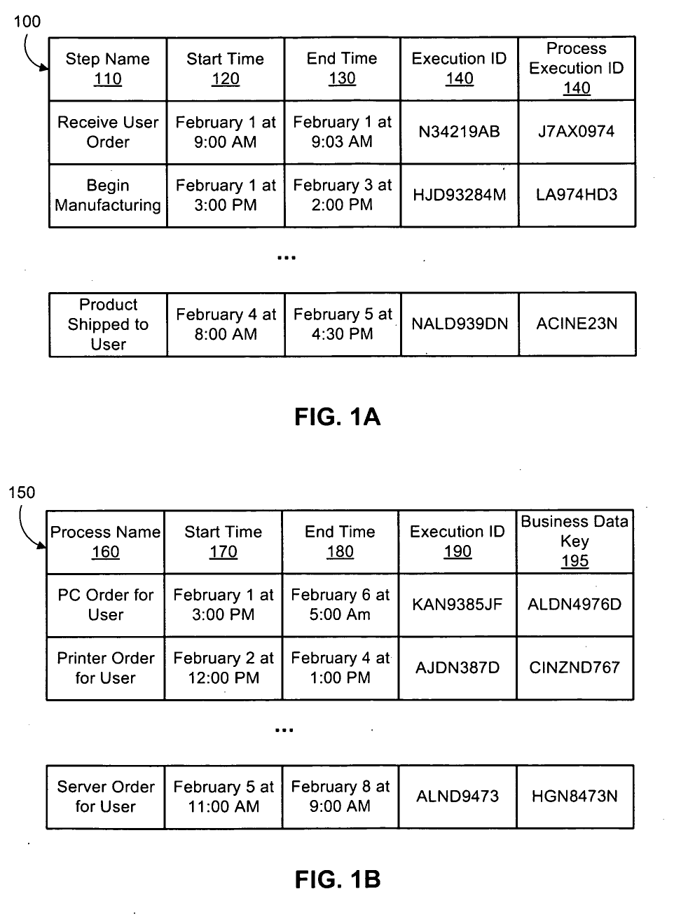

FIG. 1A shows an exemplary step execution table 100 that is associated with each execution of a process step. The step data table includes the following attributes: Step Name 110 (identifying the name of the particular step); Start Time 120 (indicating the time corresponding to the start event of a step execution); End Time 130 (indicating the time corresponding to the end event of a step); Execution ID 140 (indicating a unique identification of a step execution); and Process Execution ID 150 (indicating a unique identification of the process execution (i.e., process) instance) to which the step belongs). The Step Name, Start Time, End Time, Execution ID and Process Execution ID attributes are arranged in columns of the step data table. Each row of the step data table corresponds to the execution of a respective step of the process. In other words, if the process contains five steps and two executions of the process have been completed, then there will be ten (two times five) rows in the step data table, with each row containing values for the attributes Step Name, Start Time, End Time, and Execution ID.

FIG. 1B shows an exemplary process execution table 150 that is associated with each execution of a process. The process data table includes the following attributes: Process Name 160 (indicating a name of the process), Start Time 170 (indicating the time corresponding to the start of a process execution); End Time 180 (indicating the time corresponding to the end of a process execution); Execution ID 190 (indicating a unique identification for a process execution); and Process Business Data Key 195 (indicating a unique identification of the business entity associated to the process execution). This table records executions of a process (e.g., each processed order).

The step execution and process execution tables are generic and can be used for any business process.

Describing a View of the Process and Mapping to IT Events

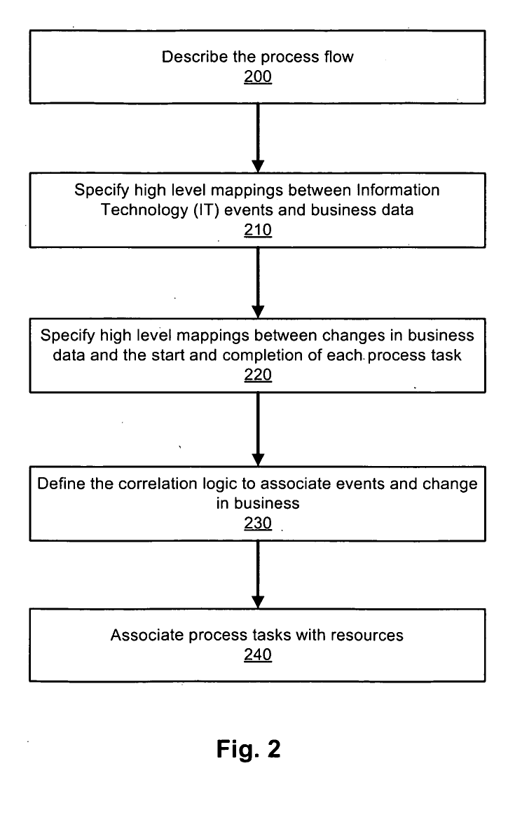

FIG. 2 is a flow chart that enables a user to describe an abstracted view of the process and how progressions map to underlying IT events.

According to block 200, the process model is described. In fact, an abstract view of the actual process according to the user perspective is described. For example, a user describes its view of an existing process model for paying invoices. This view includes receiving an invoice, importing an image of the invoice, creating a work object and an index, validating the index, auditing the invoice, correcting the invoice, and accepting or rejecting the invoice. In contrast the actual process may have hundreds of low level steps that are not relevant for business intelligence applications (e.g., accessing a database).

According to block 210, high level (declarative) mappings are specified between IT events and business data. For instance, this modeling step includes mapping an event given by a submission of a form on a given Uniform Resource Locator (URL) to the creation of a new purchase order record.

According to block 220, high level (declarative) mappings are specified between changes in business data and the start and completion of each process step. For example, a change occurs to the status value “accepted” in the po_status value of a Purchase_Order_Data instance that is associated with the end of the NotifyAcceptance process step.

According to block 230, correlation logic is defined to associate (a) IT events with the correct business data instance and (b) a business data instance to the appropriate business process instance. For the example of the previous high level mapping, the correlation logic indicates that the instance of the NotifyAcceptance step that should be updated is the one whose Process Execution ID (i.e., process instance identifier) is the same as the identifier of the Purchase_Order_Data instance that has been updated.

According to block 240, process steps are associated with resources. For example, an association is made between a specific web server and the task Receive_PO_Request.

ETL Process Data Warehouse with Process Execution Data

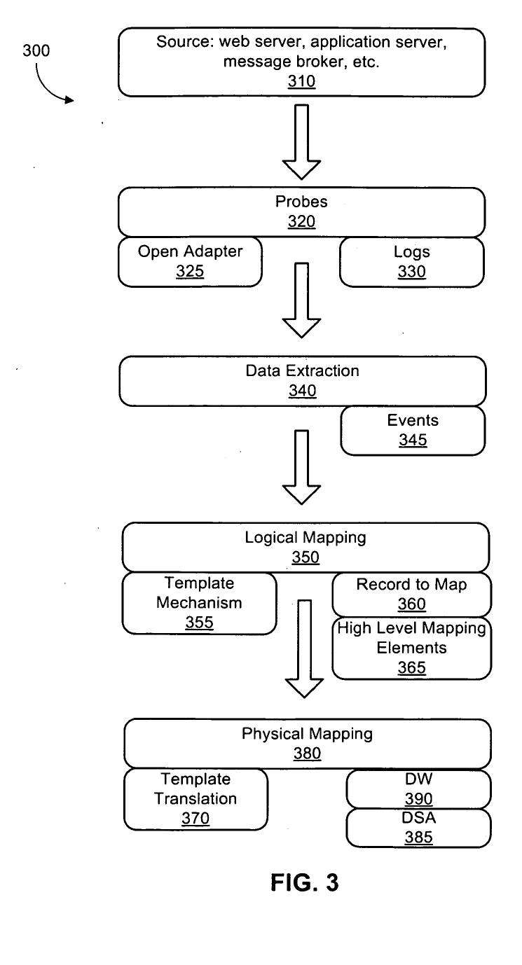

FIG. 3 provides a system 300 for extracting, transforming and loading (ETL) the process data warehouse with process execution data. The system 300 extracts events and performs transformations according to the mappings. Specifically, the system automates the design and implementation of the ETL process for warehousing business processes.

A probing mechanism 310 (e.g., Open Adaptor 325) captures the events from different sources 310 (e.g., a web server, an application server, or a message broker) and stores the events in logs 330.

Once the events 345 are captured, the next step is to gather the events or perform data extraction 340 (a procedure that corresponds to the extraction phase in the ETL process) and then to generate logical mappings 350.

The logical mappings 350 provide a method for representing the high level user-defined specifications that only define what the mappings are, as low level ones that describe how to execute the mappings for a given event or a given business data change (i.e., how to interpret the high level mappings at run-time to update process execution data in the warehouse). Common aspects are factored into a generic solution that applies to any business process. In doing so, a template mechanism 355 automates the generation of logical mappings by instantiating predefined templates that embody the operational semantics of the common aspects of the transformations with specific record data (event or business data change) and high level mapping elements 365 and record to map 360.

After the logical mappings 350 are generated, a translation mechanism 370 is used to automatically generate physical (executable) mappings 380 from the logical ones 350. The results of these mappings are stored in the staging area 385 (intermediate results) or in the data warehouse 390 (final process progression data).

The logical mappings 350 are automatically generated from the high level (declarative) mappings and the correlation logic defined by the user at modeling time and accessible from the modeling tool repository. A template-based approach is used where the semantics of the transformations used to create the mappings are embedded in mapping templates. When an IT event or a business data change is processed, along with the corresponding declarative mapping it populates the respective mapping template and in that way, the logical mapping (i.e., instantiated mapping template) is ready to feed the next phase. This logical mapping is still not executable, and in fact, it is agnostic to any specific ETL implementation tool or language.

The physical mappings 380 are expressed in a specific implementation language (e.g., C, Java, SQL, XML) and are automatically generated from the logical ones (specifically, from the instantiated mapping templates which comprise the output of the previous level). Translators combine the logical templates with appropriate physical operators that correspond to specific ETL engines (e.g., Informatica Power Center, Oracle Warehouse Builder) or implementation languages (stored procedures, scripts, and so on).

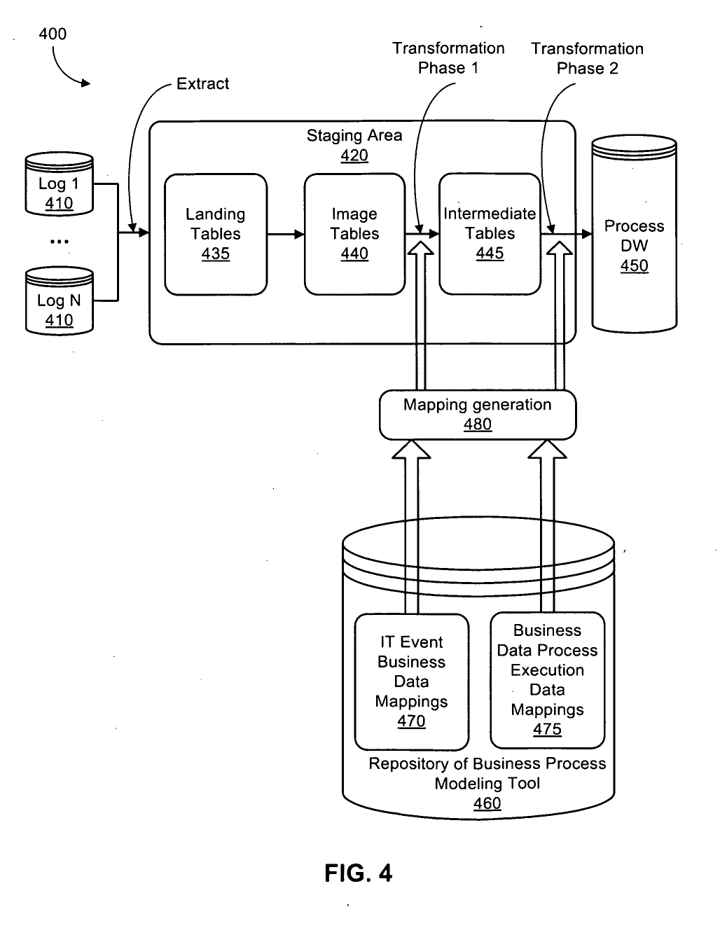

FIG. 4 shows a two-phase mapping system or process 400 to automate the design and implementation of the ETL that populates the business process warehouse.

In contrast to the way ETL is normally done in data warehousing (where data extracted from the source(s) lands into a staging area and a single transformation stage maps it into the target warehouse tables), exemplary embodiments use a two-phased transformation stage (shown as transformation phase 1 and transformation phase 2). This two-phased transformation is the result of a data independence requirement where the events monitored in the underlying systems are mapped to data changes (first phase of the transformation) and from those to process progression (second phase of the transformation). This data independence shields the process warehouse from changes in the IT infrastructure. In addition, it is common that process steps manipulate business data so the two-phased transformation becomes natural.

As discussed in more detail below, IT event logs 410 (shown as log 1 to log N) are coupled to a staging area 420 that includes landing tables 435, image tables 440, and intermediate tables 445. Load from the staging area 420 is stored in process data ware house 450 after transformation (i.e., execution of the physical mappings). The staging area is in communication with the repository 460 of a business process modeling tool (e.g., HP's Business Process Intelligence (BPI)). The repository stores the high level mappings (i.e., IT event to business data mappings 470 and business data to process execution data mappings 475) that are used as input to the mapping generation 480 that feeds the two transformation phases with the appropriate mappings.

The mappings used in both transformation phases are those declarative (high level) ones defined with a business process modeling tool (e.g., Hewlett-Packard's BPI) as part of the modeling activity. The two phases correspond to the two types of mapping that the user specifies along with the abstracted process model (i.e., user view of the process): (a) mappings from IT events data to business data changes, and (b) mappings from the latter to process progression data. Both kinds of mappings are processed analogously.

First, logical mappings are generated from the user-defined declarative ones via the use of templates. Second, physical mappings are produced from the logical ones via specific translators. The two-level mapping process is orthogonal to the two-phased transformation one: both levels of mappings apply to each transformation phase.

Automatic Maintenance of the Staging Area

A procedure automates the creation and maintenance of the staging area 420 where IT event data extracted from the source logs 410 not only lands but is mapped to a set of changes on abstract business data (first phase of the transformation).

The staging area 420 in ETL is a database (alternatively, files) where extracted data is staged before being loaded into the data warehouse 450. The staging area serves two purposes: as a landing area where extracted data lands, eliminating the need to repeat an extraction if anything goes wrong (extracting data can impact the operation of the source), and as a working area where data is prepared for loading. It is in the staging area where different sets of tables (landing tables 435, image tables 440, and intermediate tables 445) are created. The intermediate tables 445 are an artifact to support the two-phased transformation stage where the result from the first transformation phase is staged to be used as input to the second transformation phase.

To populate the process data warehouse 450, data is first extracted from the different event log databases 410 into the landing tables 435 of the staging area 420. To define the schema of such tables, one exemplary embodiment uses a graphical user interface (GUI) that allows the user to check off the tables and fields of the source logs from where event data will be extracted. This procedure generates a schema definition script in SQL Data Definition Language (DDL) for creating the corresponding landing tables 435. It is in these tables where the extracted event data will land. For example, if a message broker log had a table for messages with fields <message_id, value1, value2, timestamp> and all of these fields are extracted to map a message event into a business data change, then they will be checked off and the following definition statement will automatically be generated (modifying the definition imported from the source):
USE LANDING_AREA
CREATE TABLE MESSAGE (message_id(chart[15]), value1 (vchar[30]), value2(char[30]), TS [datetime]).

The same happens for the image tables. There is one image table for each landing table with exactly the same schema. Therefore, the same DDL script used to create the landing tables is used to create the image tables as well.

Once event data has been extracted into the corresponding landing table 435, the data is checked for errors and for determining if it is a new event or an event that has been extracted before. To this end, the tuples in the landing tables 435 are compared with their counterparts in the image tables 440. Image tables, as the name suggests, keep an image of the records extracted from the sources since the first extraction cycle (or since the last time the staging area was flushed).

Once data in the landing tables is checked, erroneous data is sent to error tables for later reprocessing. Non erroneous data is copied to the image tables, while the landing tables are truncated just before the next extraction. Scripts are generated to do the necessary comparisons and detection of errors. For example, for each landing-image table pair, a script is automatically created to compare the key of each tuple in the landing table with those in the image table. If a match is found, the remainder of both tuples is compared, and if they still match, then the tuple in the landing table is discarded as it is considered a duplicate (i.e., a tuple that had already been extracted in a previous ETL cycle). If there is no match on the key of a tuple in a landing table, then it is a new event.

For example, if there is a tuple <100, 500, ‘rejec’> in the MESSAGE landing table with schema<message_id, value1, value2>, and in the corresponding image table another tuple with message_id=100 is found, and the values of its other attributes are <500, ‘reject’>, it means that the event data had already been extracted and processed in some previous ETL cycle so it is discarded. However, if there is no other tuple with message_id=100 in the image table, then the event data is copied to the image table along with the current timestamp. It is the new data in the image tables that is transformed into the target tables of the process data warehouse.

To implement the two-phased transformation, exemplary embodiments use intermediate tables 445 whose purpose is to stage the output of the first transformation phase to be used as input for the second transformation phase. These tables have a same or similar schema as their counterpart business data tables in the process data warehouse. Therefore, the same DDL used to create those tables is used for the creation of the intermediate ones. In contrast to the other two sets of tables (i.e., landing and image) which are populated by copying data using an SQL statement of the form INSERT INTO table SELECT attributes FROM source_table|landing_table, the intermediate tables are populated by the execution of the physical mappings from IT events to business data changes (first phase). For example, once a message has been extracted into the corresponding MESSAGE landing table, and it has been detected as a new event and copied into the corresponding image table, the new row is mapped into an update to a business data instance (e.g., update of the status of an existing order) or an insert of a new business data instance (e.g., insert of a new order data instance).

Once the structures of the different tables in the staging area are created, they are populated. Landing tables are completely refreshed at every extraction cycle by inserting the data extracted from the event log sources into the corresponding landing tables using INSERT-SELECT SQL statements. Image tables are incrementally refreshed at every extraction cycle by copying the appropriate tuples (i.e., new inserts) from landing tables into the corresponding image tables. Intermediate tables are populated as the result of executing the physical mappings from IT events to business data changes. Finally, data in the intermediate tables is mapped to process progression data loaded into the target tables of the process data warehouse.

A solution that creates and populates the staging area is incomplete if it cannot cope with change. Log structures and business data structures can change, so the staging area is automatically maintained. Exemplary embodiments detect changes to the source schema by periodically retrieving and comparing the source schema definitions with their previous versions. This prompts the user to indicate which of those changes are relevant from a reporting perspective (e.g., not all columns of a newly added table are required for warehousing and reporting, whereas modifications or deletions of columns with a counterpart in the staging area have an impact). For those changes identified by the user as relevant, corresponding ALTER TABLE statements to modify the staging area schema are automatically issued.

Mapping Generation

This section describes how mappings are actually generated. As explained above, as part of the abstract process model, the user specifies two kinds of mappings: a) mappings from IT events data to business data changes and b) mappings from the latter to process progression data. Both kinds of mappings are processed analogously, except that they use different sets of input and output tables. In case a), input data is taken from the image tables and output (mapped) data is inserted into intermediate tables. In case b), intermediate tables contain the input data whilst mapped data is loaded into target tables in the process data warehouse. The high level mappings specified by the user are automatically processed to produce low level (i.e., physical) mappings that are executed during the transformation stage of each ETL cycle.

User-defined mappings are declarative. They only specify the correspondences between IT events data and business entity data, and between business entity data and abstract process steps (e.g. populating the value of the audit result for an invoice corresponds to the end of the audit step for that invoice). They do not specify how to execute them (i.e., how to interpret them at run-time to update business and process execution data in the data warehouse). To solve this problem, one exemplary embodiment includes a mapping generator or mapping generation (FIG. 4 at 480) that derives prescriptive (low level) executable mappings from declarative (high level) ones accessible from the business process modeling tool repository 460.

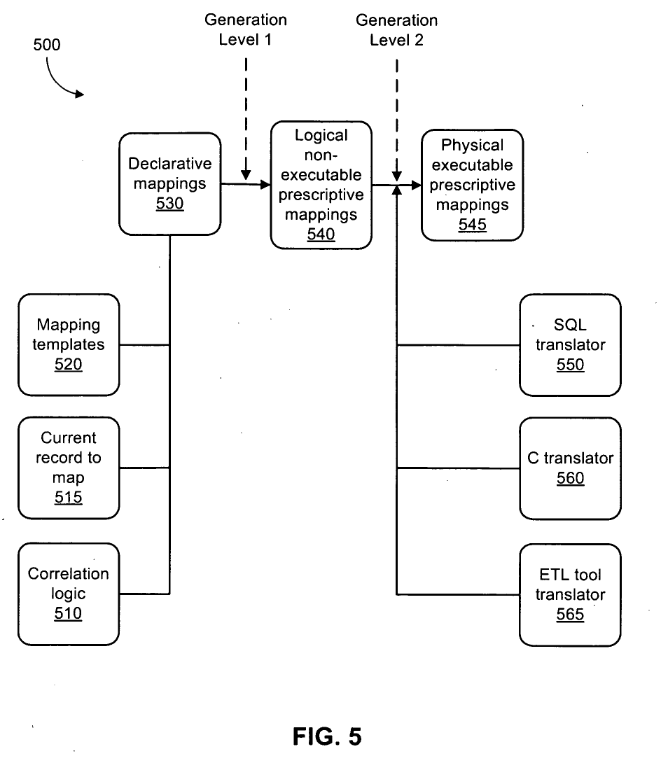

The mapping generator is designed such that it provides independence of the language used to execute the mappings. The generator is agnostic with respect to the underlying tool (i.e., home grown or commercial) supporting the execution of ETL processes. In order to accomplish this design, the generation has two levels (discussed in FIG. 5).

FIG. 5 shows the two levels of mapping generation levels of a mapping generator 500. The generator transforms the user-defined declarative mappings to logical mappings first and then the latter ones to physical mappings. In the first level, it uses the current record to map 515, the declarative mappings 530, correlation logic 510, and mapping templates 520. In the second level, an implementation language translator like ETL tool translator 565, C translator 560, SQL translator 550 is used. In a first mapping level, prescriptive logical (i.e., non-executable) mappings are generated, while in the second one prescriptive executable ones are produced.

For the first level (i.e., logical mapping generation) a template language is used to predefine templates. This language includes ETL specific operators like assign_surrogate (to assign a surrogate key to a tuple) and lookup (to retrieve a surrogate key). The language is easy to interpret while at the same time provides the desired independence of the actual language used to execute the transformations. Specific translators from this language to different implementation languages are used for the second level of the mapping generation (i.e., physical mapping generation). However, exemplary embodiments are also applicable where such a translator has not been developed yet or cannot exist. Such is the case when a commercial ETL tool with no API to programmatically enter the prescriptive mappings nor with functionality to import XML ETL scenarios, is used. In these situations, the user manually performs the translation.

One aspect of the mapping generator 500 is an extensible set of mapping templates, which consist of parameterized logical scripts written in the template language that indicate how to execute the mappings. The parameters are event, business entity, and process step-related (see the example below). Templates get instantiated by the declarative mappings stored in the process modeling tool repository and by the current record being processed (i.e., event data record or business data change record) to produce prescriptive logical mappings (first level mapping). As mentioned before, these mappings are not executable, but later are translated into an executable language (second level mapping) as explained above.

When a declarative mapping is specified, the user first selects a mapping type (e.g., Business_Entity_to_End_Step). Once the type is selected, the appropriate mapping form is displayed for the user to fill it out with the mapping elements associated to that type of mapping. The mapping elements are stored as an XML snippet in the business process modeling tool repository. Later, when the mapping is retrieved, its type becomes readily available enabling the identification of the corresponding mapping template which in turn is retrieved from the Mapping Generator repository. As shown in FIG. 5, the Mapping Generator takes as input the declarative mapping 530, the record to be mapped 515 (i.e., event data instance or business data instance), the correlation logic 510, and the mapping template 520 and uses the first three to instantiate the last one. Notice the correlation logic 510 is given as part of the modeling specification and identifies the target record that correlates to the source record of the mapping.

The following discussion illustrates an example of the first level of the mapping generation (i.e., logical mappings). This example provides a simplification of one of the templates that are predefined to prescribe how to interpret a declarative mapping at execution time. Alternate examples and embodiments also identify a number of different mapping types with complex execution semantics.

A user-defined declarative mapping establishes a correspondence between populating the Result attribute of an invoice (update operation) and the end of the Audit step of the Invoice_payment process. Being a mapping of type Business_Entity_Change_to_End_Step it contains the following elements:
(1) The input object type (InObjType) is the name of business data table where the input record to the mapping is located. Its value is the table name Invoice_Business_Data.
(2) The input attribute (InAtr) is a list of name(s) of the business data attribute(s) that will be mapped.
(3) The operation (Operation) is the one triggering the execution of the mapping. For this type of mapping it is the insertion or the update of a tuple (for example, it is the update of the result attribute of an invoice instance).
(4) The condition (Cond) is satisfied for the mapping to be activated. It is typically a condition on the value(s) of one or more attributes of the business data instance but it could be a more complex condition.
(5) The input category (InCateg) is the category of the input data to the mapping. In general, it can be an IT_event, or a business data change (Business_Entity).
(6) The output object (OutObj) is the name of the abstract process step that will progress via the mapping execution. This is the audit step.
(7) The output attribute (OutAtr) indicates the action on the process step instance. It can be either start or end (for example, it marks the end of the audit step).
(8) The output type (OutObjType) is the name of the table where the record obtained from the mapping is (if the record already exists) or will be (if it is a new record) located. For our example, it is table Step_Execution.

Continuing with our example, correlation logic indicates that the instance of step type Audit belonging to the process execution whose Business Data Key is equal to the key of the invoice record being mapped is the one to be updated.

An Invoice_Business_Data record contains many attributes but includes the one(s) specified in the input attribute (InAtr) of the declarative mapping (e.g., (audit_result) and the one(s) specified in the correlation logic (invoice_key) that are relevant for this mapping (in general, the latter is the business key).

A mapping template defines the operational semantics of mappings different types. It gives a logical specification of the set of actions that are performed to execute such mappings without saying how to implement them (that depends on the language chosen to implement the mappings that will be executed during ETL cycles). For example, the template needed is the type Business_Entity_to_End_Step. This template is parameterized by the business entity type (% BE_T), the attribute name of the business entity identifier (% BE_I) and the task type (% TT). The actions prescribed in this template are the followings:
1. Lookup operation to obtain the surrogate key of the current system time in seconds.
2. Lookup operation to obtain the business entity surrogate key for the instance to be mapped.
3. Lookup operation to obtain the surrogate key for the given task type (in our case for task type audit).
4. Retrieve the start time of the process step to be updated to mark its progression.
5. Lookup operation to retrieve the surrogate key of the start time obtained in the previous action.
6. Update the end time of the process step instance with the surrogate key of the system time obtained in the first action.
7. Update the duration of the process step instance with the value obtained from the difference of the end timestamp in seconds minus the start timestamp also in seconds.

The logical mapping is an instance of the previous template where all parameters have assigned values. For example, the business entity type parameter (% BE_T) obtains its value from the InObjType attribute of the declarative mapping. The attribute name of the business entity identifier parameter (% BE_I) finds its value in the correlation logic. Finally, the task type parameter (% TT) gets its value from the OutObj attribute of the declarative mapping.

In the second level of the mapping generation (i.e., physical mapping), a language translator translates the logical mapping (i.e., instantiated template) to the chosen implementation language. The instantiated logical templates determined in the previous level are translated to their physical implementations (i.e., physical mappings). To this end, a physical language is chosen, such as SQL, PL/SQL, C++, Java, XML (there exist both commercial—e.g., Informatica's Powercenter—and open source ETL tools—e.g., Pentaho's Kettle or PDI—that support importing ETL scenarios as XML files) or any other procedural or scripting language. Specific translators are built for each of these languages to take logical mappings as input and produce the corresponding physical (executable) mappings in the specific implementation language.

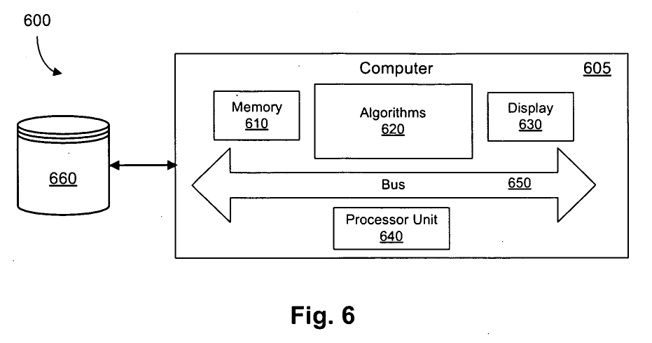

FIG. 6 is a block diagram of a computer system 600 in accordance with an exemplary embodiment of the present invention. In one embodiment, the computer system includes a database or warehouse 660 (such as a multidimensional database) and a computer or electronic device 605 that includes memory 610, algorithms 620, display 630, processing unit 640, and one or more buses 650.

In one embodiment, the processor unit includes a processor (such as a central processing unit, CPU, microprocessor, application-specific integrated circuit (ASIC), etc.) for controlling the overall operation of memory 610 (such as random access memory (RAM) for temporary data storage, read only memory (ROM) for permanent data storage, and firmware). The processing unit 640 communicates with memory 610 and algorithms 620 via one or more buses 650 and performs operations and tasks necessary for executing embodiments in accordance with the invention. The memory 610, for example, stores applications, data, programs, algorithms (including software to implement or assist in implementing embodiments in accordance with the present invention) and other data.

Definitions

As used herein and in the claims, the following words are defined as follows:

The term “business process” is a collection of related activities that produce a specific service or product for a customer.

The term “business intelligence” or “BI” refers to software applications and technology that gather information from a data warehouse. BI applications provide historical, current, and predictive views of data stored in the warehouse and business operations associated with the stored data. Examples of BI applications include reporting, analytics, data mining, Online Analytical Processing (OLAP), predictive analysis, and business performance management.

The term “database” is records or data stored in a computer system such that a computer program or person using a query language can send and/or retrieve records and data from the database. Users pose queries to the database, and records retrieved in the answer to queries contain information that is used to make decisions.

The term “database management system” or “DBMS” is computer software designed to manage databases.

The term “extract, transform, load” or “(ETL)” in a database or data warehouse extracting data from a source, transforming the data for operational requirements, and loading the data into the database or data warehouse.

The term “multidimensional database” is a database wherein data is accessed or stored with more than one attribute (a composite key). Data instances are represented with a vector of values, and a collection of vectors (for example, data tuples) are a set of points in a multidimensional vector space.

The term “OLAP” and “online analytical processing” is business intelligence that uses relational reporting and data mining in a multi-dimensional model to answer queries to stored data.

The term “Structured Query Language” or “SQL” is a database computer language that retrieves and manages data in a relational database management systems (RDBMS), database schema creation and modification, and database object access control management. SQL provides a language for an administrator or computer to query and modifying data stored in a database.

In one exemplary embodiment, one or more blocks or steps discussed herein are automated. In other words, apparatus, systems, and methods occur automatically. The terms “automated” or “automatically” (and like variations thereof) mean controlled operation of an apparatus, system, and/or process using computers and/or mechanical/electrical devices without the necessity of human intervention, observation, effort and/or decision.

The methods in accordance with exemplary embodiments of the present invention are provided as examples and should not be construed to limit other embodiments within the scope of the invention. Further, methods or steps discussed within different figures can be added to or exchanged with methods of steps in other figures. Further yet, specific numerical data values (such as specific quantities, numbers, categories, etc.) or other specific information should be interpreted as illustrative for discussing exemplary embodiments. Such specific information is not provided to limit the invention.

In the various embodiments in accordance with the present invention, embodiments are implemented as a method, system, and/or apparatus. As one example, exemplary embodiments and steps associated therewith are implemented as one or more computer software programs to implement the methods described herein. The software is implemented as one or more modules (also referred to as code subroutines, or “objects” in object-oriented programming). The location of the software will differ for the various alternative embodiments. The software programming code, for example, is accessed by a processor or processors of the computer or server from long-term storage media of some type, such as a CD-ROM drive or hard drive. The software programming code is embodied or stored on any of a variety of known media for use with a data processing system or in any memory device such as semiconductor, magnetic and optical devices, including a disk, hard drive, CD-ROM, ROM, etc. The code is distributed on such media, or is distributed to users from the memory or storage of one computer system over a network of some type to other computer systems for use by users of such other systems. Alternatively, the programming code is embodied in the memory and accessed by the processor using the bus. The techniques and methods for embodying software programming code in memory, on physical media, and/or distributing software code via networks are well known and will not be further discussed herein.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1) A method for designing and implementing an Extract-Transform-Load (ETL) process for a business process data warehouse, comprising:
extracting, from logs with a computer, information technology (IT) events that indicate start and completion times of a business process;
transforming, with the computer, the IT events into business data changes that are agnostic to multiple different ETL implementation languages;
transforming, with the computer, the business data changes into process progression data; and
loading the process progression data in a data warehouse.

2) The method of claim 1, wherein all phases of the ETL design are automated without user intervention to reduce time and effort to design and implement the ETL process.

3) The method of claim 1 further comprising, extracting the logs into a staging area where a comparison process identifies new IT events.

4) The method of claim 1 further comprising, specifying declarative mappings between the IT events and the business data changes and between the business data changes and the process progression data.

5) The method of claim 1 further comprising, a first phase where the IT events and corresponding declarative mappings and correlation logic are processed to instantiate mapping templates that are agnostic to any specific ETL implementation tool and ETL language thereby generating logical maps for transforming the IT events into business data changes.

6) The method of claim 1 further comprising, a second phase where the business data changes and corresponding declarative mappings and correlation logic are processed to instantiate mapping templates that are agnostic to any specific ETL implementation tool and ETL language thereby generating logical maps for transforming the business data changes into process progression data.

7) The method of claim 1 further comprising:
generating physical maps from the logical maps using translators from template language to a specific ETL implementation language, wherein the physical maps are expressed in a specific ETL implementation language.

8) A tangible computer readable storage medium having instructions for causing a computer to execute a method, comprising:
receiving information technology (IT) events from execution of a business process;
capturing, with instantiated templates in a first phase, semantics of transformations of the IT events to business data changes;
capturing, with instantiated templates in a second phase, semantics of transformations of the business data changes into process progression data;
translating the instantiated templates herein called logical mappings into physical executable mappings;
executing the physical executable mappings to produce process progression data; and
transferring the process progression data to a data warehouse for storage.

9) The tangible computer readable storage medium of claim 8, wherein both the first and second phases include two mapping levels given by logical mappings and physical mappings with the logical mappings being agnostic with respect to multiple different Extract-Transform-Load (ETL) implementation languages.

10) The tangible computer readable storage medium of claim 8 further comprising:
extracting the IT events to a staging area;
performing both the first and second phases of mapping and in each one performing both first and second levels of mapping after the IT events are extracted to the staging area.

11) The tangible computer readable storage medium of claim 8 further comprising:
generating, in the first level, logical mappings from user-defined declarative mappings with the use of templates;
generating, in the second level, physical mappings from the logical mappings, wherein the first and second levels occur in both mapping phases of IT events to business data changes and business data changes to process progression data.

12) A computer system, comprising:
a computer that extracts events that indicate start and completion times of steps of a business process execution, transforms in a first phase the events into business data changes, and transforms in a second phase the business data changes into process progression data; and
a data warehouse that stores the process progression data.

13) The computer system of claim 12, wherein the data warehouse includes a step data table that includes for each event in the business process a step name that identifies a step, a start time that indicates a time when the step name starts, an end time that indicates a time when the step name ends, a unique identification for the step name.

14) The computer system of claim 12, wherein the data warehouse includes a process data table that includes a process name that identifies the business process, a start time that indicates a time when the business process starts, an end time that indicates a time when the business process ends, a unique identification for the business process, the process data table being generic and applicable to multiple different business processes.

15) The computer system of claim 12, wherein the computer extracts the events into a staging area that includes (1) landing tables that stored the events extracted from logs, (2) image tables that maintain a previous versions of records extracted from the logs, and (3) intermediate tables where results of the first mapping phase are staged to be used as input to the second phase.

16) The computer system of claim 12, wherein high level mappings specified by a user are automatically processed by the computer to produce low level mappings that are executed during the first and second phases of each ETL cycle.

17) The computer system of claim 12, wherein templates capture semantics of transforming the events to business data changes and semantics of transforming the business data changes to execution data, the templates being instantiated by declarative mappings and correlation logic stored in a repository and by a current event and business data change being processed.

18) The computer system of claim 12 wherein the computer further generates logical maps that are agnostic to any particular ETL tool and generates physical maps from the logical maps, wherein the physical maps are expressed in a specific ETL implementation language.
